(19) United States
(12) Patent Application Publication
(10) Pub. No.: US 2004/0103442 A1
(43) Pub. Date: May 27, 2004

(54) End of line monitoring of point-to-multipoint network

(76) Inventor: John W. Eng, Westminster, CO (US)

Correspondence Address: The Law Offices of William W. Cochran, LLC, Suite 230, 3555 Stanford Road, Fort Collins, CO, 80525, US

(21) Appl. No.: 10/307,016

(22) Filed: Nov. 27, 2002

(51) Int. Cl. H04N 7/173

(52) U.S. Cl. 725/126; 725/107; 725/111; 725/118; 725/120

(57) ABSTRACT

A service channel is used in a bi-directional communications network such as a DOCSIS cable modem system, fixed broadband wireless system, or other network to transmit in the upstream direction. The service channel communications do not require a properly functioning downstream communications link to operate. Remote devices may thusly be able to indicate to a central server various status related data that may assist in identifying problems with the network or aid in proper installation of devices on the network.

### BACKGROUND OF THE INVENTION

a. Field of the Invention

The present invention pertains to two-way communication networks and specifically to end-of-line status monitoring of the point-to-multipoint portion of a shared, two-way communication network.

b. Description of the Background

Shared communication networks with point-to-multipoint transmission in the downstream direction, and multipoint-to-point transmission in the upstream direction pose many problems for establishing communication protocols. For example, in a two-way hybrid fiber-coaxial (HFC) cable television distribution network, many cable modems may compete for communication bandwidth in both the upstream and downstream directions. A currently accepted standard protocol is Data-Over-Cable Service Interface Specification (DOCSIS) that uses the downstream path to indicate exactly when each modem is able to transmit in the upstream direction. Such protocols are used in many applications including wireless protocols such as IEEE 802.16 and other protocols.

Such protocols require that the downstream communication path must be properly functioning for any upstream communication to happen. In cases where the downstream path may have a signal to noise ratio (SNR) too low for the cable modem to receive data, the downstream path may be unusable while the upstream path may function correctly. In the example of a cable television plant, causes of such low signal to noise ratio may be poor plant design, improperly functioning amplifiers and other network components, external environmental noise, damaged cables, or other factors.

When a communication device is connected to a network that requires a good downstream connection to properly function, and the downstream connection has a low signal to noise ratio or is otherwise troublesome, that device may not be able to function at all. In such cases, a service call may require a service technician to respond to a subscriber's location. Such service calls are very expensive and time-consuming.

It would therefore be advantageous to provide a system and method for end-of-line measuring and monitoring the signal quality of downstream communications and transmitting the measurements upstream without requiring the downstream channel to be fully functional. It would be further advantageous if the method could be performed automatically when a downstream channel is non-functional.

### SUMMARY OF THE INVENTION

The present invention overcomes the disadvantages and limitations of the prior art by providing a system and method for upstream-only communication for networks where the primary communication mechanism requires both upstream and downstream signals to properly function. The system and method utilizes an upstream service channel for periodic transmissions that may occur at random intervals so that collisions may be avoided. Alternatively, the system and method utilizes the upstream service channel for informing the central control management system only when signal quality of the downstream transmission path is determinated to be below a pre-determined threshold.

The present invention may therefore comprise a method for upstream communications in a bi-directional communications network wherein the primary form of upstream communication requires properly functioning downstream communication wherein the network is characterized by a central station and a plurality of remote transceivers comprising: providing at least one service channel outside of the bandwidth allocated for the upstream communication; detecting at least one problem with the downstream communication by one of the remote transceivers; creating a status transmission comprising an identifier for the one of the remote transceivers; sending the transmission on the at least one of the service channels from the one of the remote transceiver to the central station using the service channel; repeating the step of sending the transmission after waiting a predetermined period of time; receiving the transmission by the central station; and identifying the one of the remote transceivers at the central station.

The present invention may further comprise a bi-directional communications network wherein the primary form of upstream communication requires properly functioning downstream communication comprising: at least one service channel outside of the bandwidth allocated for the upstream communication; a central station capable of sending downstream transmissions and receiving upstream transmissions, the upstream transmissions being transmitted within a predetermined upstream bandwidth; and a plurality of remote transceivers capable of receiving the downstream transmissions and sending the upstream transmissions, at least one of the remote transceivers capable creating a status transmission comprising an identifier for the remote transceivers, sending the transmission on the at least one service channel outside of the pre-determined upstream bandwidth from the one of the remote transceiver to the central station using the service channel.

The advantages of the present invention are that upstream communications from a remote device may occur even when downstream channels are not functioning. These communications may assist technicians in diagnosing problems with the network or with installation of various components of the network, thus drastically reducing the time and cost of sending service personnel to the customer premises.

### BRIEF DESCRIPTION OF THE DRAWINGS

In the drawings,

FIG. 1 is an illustration of an embodiment of the present invention of a cable television network with status monitoring cable modems.

FIG. 2 is an illustration of an embodiment of the present invention of a status monitoring cable modem.

FIG. 3 is an illustration of the frequency spectrum wherein the downstream channel, standard upstream channel, and service channel are located.

FIG. 4 is an illustration of an embodiment of the present invention wherein three cable modems are transmitting their respective status at random intervals on the service channel.

FIG. 5 is an illustration of an embodiment of a typical communication packet sent on the service channel.

FIG. 6 is an illustration of an embodiment of the present invention of a method for transmitting on a service channel when the downstream communication is impaired.

FIG. 7 is an illustration of a wireless embodiment of the present invention.

### DETAILED DESCRIPTION OF THE INVENTION

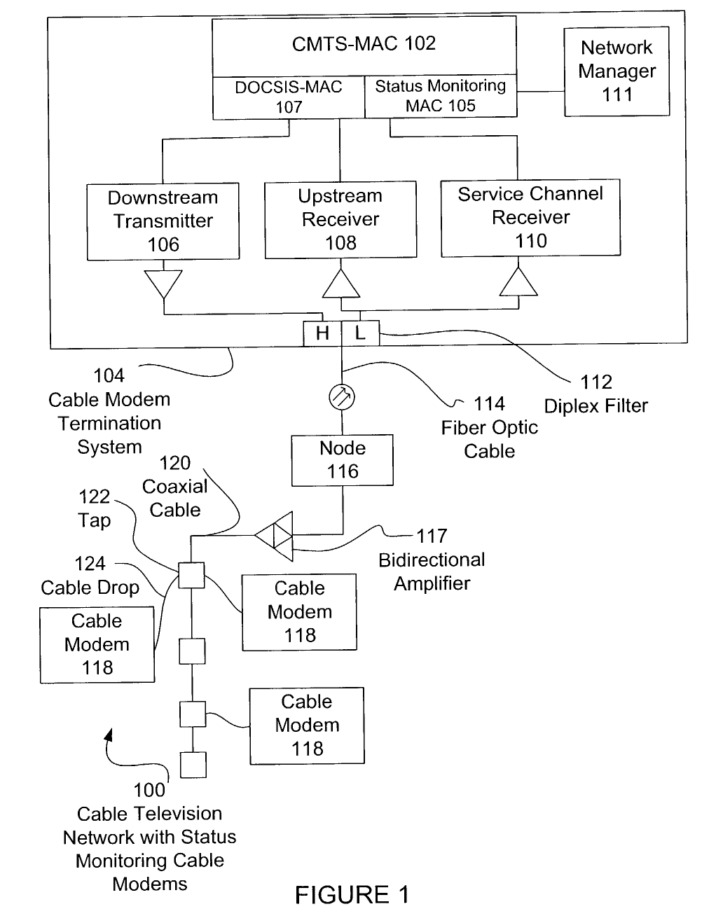

FIG. 1 illustrates an embodiment 100 of the present invention of a two-way hybrid fiber-coax (HFC) cable television network with status monitoring cable modems. The cable modem termination system (CMTS) media access control (MAC) 102 is a system of hardware and software that co-ordinates the access of the upstream and downstream transmissions of a plurality of cable modems of the two-way cable television network. The CMTS 104 comprises the CMTS-MAC 102, a downstream transmitter 106, an upstream receiver 108, and a service channel receiver 110. The transmitter 106 and receivers 108 and 110 may be connected through a diplex filter 112 and a fiber optic cable 114 to a fiber node 116. The fiber node 116 is connected to cable modems 118 via bi-directional distribution amplifier 117, coaxial cable 120, tap 122 and drop cable 124.

The CMTS-MAC 102 further comprises a DOCSIS-MAC 107 and status monitoring MAC 109. The DOCSIS-MAC co-ordinates the transmissions of the downstream transmitter 106 and the upstream transmitters in cable modems 118 for normal cable modem operations. The status monitoring MAC 109 receives and decodes the status-monitoring packets from the service channel receiver 110, and then relaying the status-monitoring packets to a network manager 111. The network manager 111 provides diagnostic, alerting, and other information to service personnel as well as other functions.

The embodiment 100 illustrates a separate service channel that is used by the CMTS 104 for receiving one-way communications from the cable modems 118. The service channel 306 may be used by the cable modems 118 for various functions. For example, in cases where the downstream communication is impaired to the point where normal two-way communication is ineffective, a cable modem 118 may send a status message to the network manager 111 to indicate a problem with the particular downstream transmission path connected to the cable modem 118. In such cases, a service call or other maintenance may be required. In another example, performance data may be collected by the modem and transmitted periodically to the network manager 11.

Many problems may occur during installation of the cable modem or other two-way communication device on the cable network. Such problems may prohibit proper functioning of the cable modem. For example, incorrectly attached cabling, malfunctioning cable modem, improper software installation, or even having the power disconnected to the cable modem may be problems with the installation. If a subscriber has a problem with the cable modem installation, the subscriber may call a service technician that can verify proper connections over the phone. If the subscriber can properly attach the cable modem, and the cable modem can sense, diagnose, and transmit downstream problems to the technician with the present embodiment, the technician can determine that a problem may exist with the downstream channel.

The cable television network is illustrated only to demonstrate connectivity, and is not intended to show all of the various components that make up a complete network. Devices such as line-extender amplifiers, filters, splitters, electrical to optical converters, optical to electrical converters, upconverters, downconverters, and other devices may contribute to impairments in the transmission lines.

Standard cable modems may require both upstream and downstream communication lines to be at least partially operational for communication between the cable modem 118 and the CMTS-MAC 102 to occur. In such situations, the downstream channel may have a timing synchronization and bandwidth allocation protocol that establishes a specific time and sequence when the cable modem 118 is to transmit upstream. When the downstream channel has a large amount of impairments and therefore a low signal to noise ratio, the cable modem 118 may be unable to transmit upstream, according the conventional DOCSIS-MAC protocol

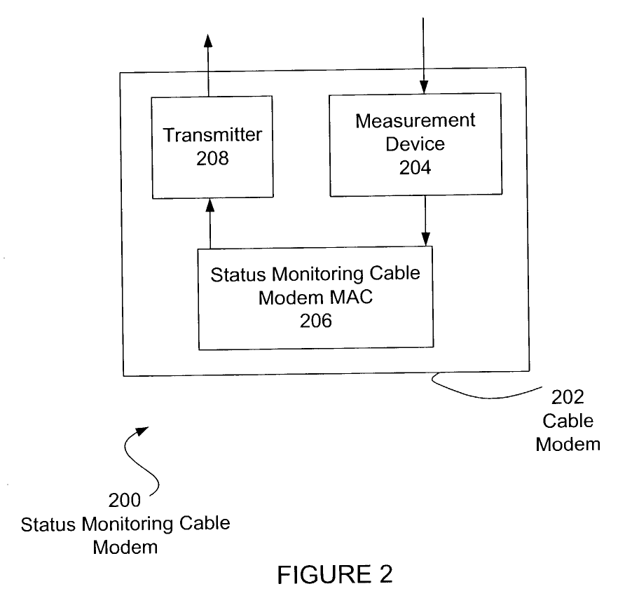

FIG. 2 illustrates an embodiment 200 of a status monitoring cable modem 202. The cable modem 202 comprises a measuring device 204, the cable modem media access control (MAC) 206, and a transmitter 208.

The status monitoring cable modem 200 may collect status parameters and transmit the parameters upstream. Further, the cable modem 200 may transmit the status parameters upstream in a one-way fashion that does not require proper downstream communication. For example, the cable modem 200 may use the transmitter 208 to send a status packet upstream on a special service channel.

The measurement device 204 may be a hardware component, software component, or combination of hardware and software that can detect and optionally measure data with the downstream signal. In some embodiments, the measurement device may measure signal to noise ratio, power level, or other performance measurements. In other embodiments, the device 204 may use software routines to monitor other factors that affect the performance of the cable modem 202. Such parameters may include the software/firmware/hardware revisions of various components of the cable modem 202, any status parameters including response to training signals, or other parameters. Those skilled in the arts will readily appreciate that the status parameters to be collected may be varied while still keeping within the spirit and intent of the present invention.

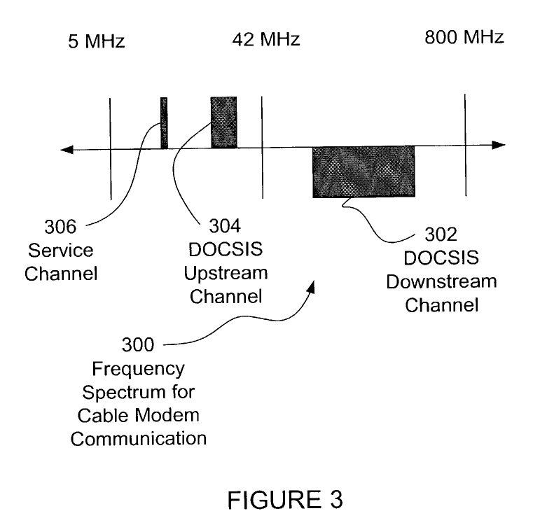

FIG. 3 illustrates the frequency spectrum 300 wherein the downstream channel 302, standard upstream channel 304, and upstream service channel 306 are located. The service channel 306 may be located in a region unused for other purposes and may be considerably noisy for high-speed communications. Transmissions on the service channel 306 may be designed with a large tolerance for noise and other variables such as using a login symbol period, robust modulation schemes such as BPSK or QPSK, and suitable error protection and correction coding.

In some embodiments, several service channels may be used so that one service channel is not overloaded by many cable modems transmitting simultaneously. In such embodiments, cable modems may be assigned different service channels as part of the firmware or software installed in the cable modem from the factory. In other embodiments, the cable modem may switch between service channels at random or based upon a user input.

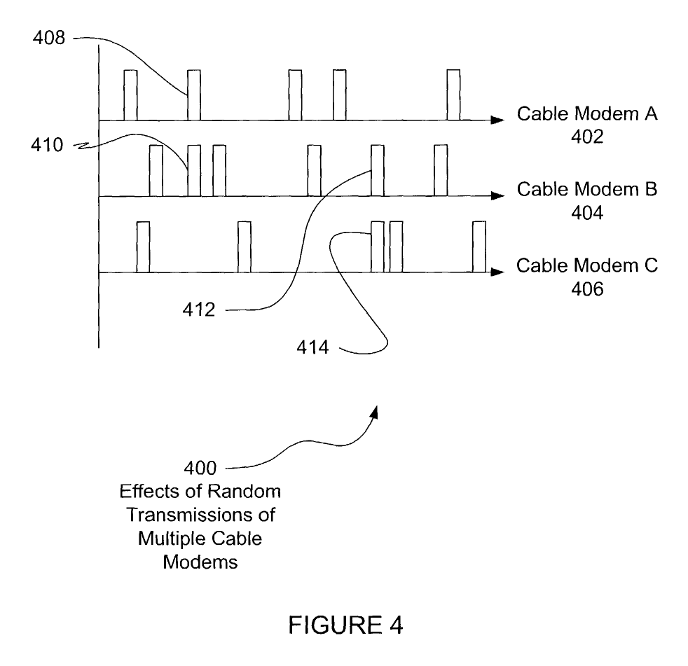

FIG. 4 illustrates an embodiment 400 of the present invention wherein three cable modems are transmitting their respective status at random intervals on the service channel. The transmissions of cable modem A 402 is shown on a timeline. Similarly, cable modem B 404 and cable modem C 406 are shown. In the illustration, each cable modem is transmitting a status package on the service channel. Transmissions 408 and 410 occurred substantially simultaneously such that a collision occurred between the two transmissions. In such a case, neither transmission would have been received by the CMTS. Because the status of each cable modem is repeatedly sent and done so at random intervals, the CMTS has a high likelihood that at least one of the multiple transmissions from each of the cable modems would have been received.

In a typical cable television distribution network, many cable modems may be transmitting on the service channel simultaneously. In some embodiments, every cable modem may be repeatedly sending status information on the service channel. In other embodiments, only those cable modems that have no downstream communication may be transmitting on the service channel. In still other embodiments, those cable modems with signal to noise ratios or other parameters that are below a certain threshold may be transmitting on the service channel.

Those skilled in the art may utilize contention-based MAC protocol such as Aloha or slotted Aloha for transmitting the status-monitoring packets. To minimize collisions, a suitable back-off algorithm such as binary-exponential backoff or P-persistent back-off can be used. The slot time for slotted Aloha may be typically set to greater than the maximum loop delay for the upstream and downstream transmission paths, plus the time duration of the status-monitoring packet burst. Such techniques, as well as other techniques may be used by those skilled in the art while maintaining within the scope and intent of the present invention.

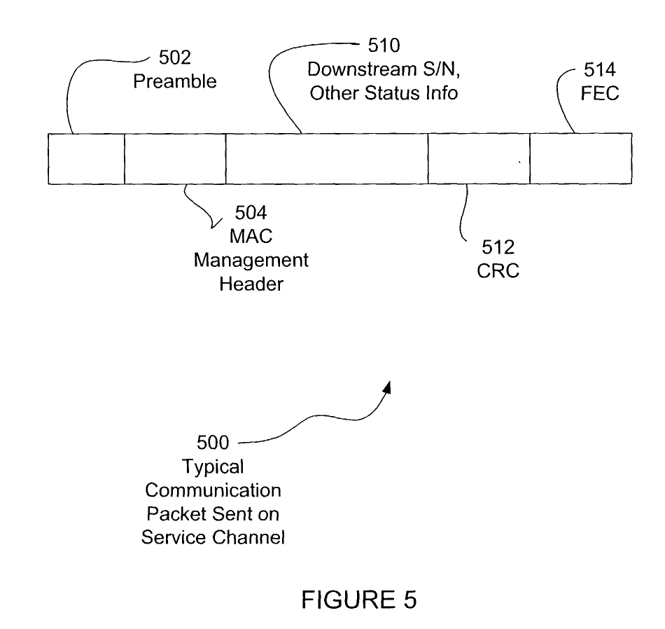

FIG. 5 illustrates an embodiment 500 of a typical communication packet sent on the service channel. Block 502 is a preamble, block 504 is the MAC management header, which may contain a cable modem unique identifier such as its MAC address, block 506 is the downstream signal to noise ratio, status indicators, and/or other status information, block 512 is the cyclical redundancy check (CRC) information, and block 514 is the forward error correction (FEC) information. Those skilled in the art will appreciate that other transmission packet configurations may be used while maintaining within the spirit and intent of the present invention.

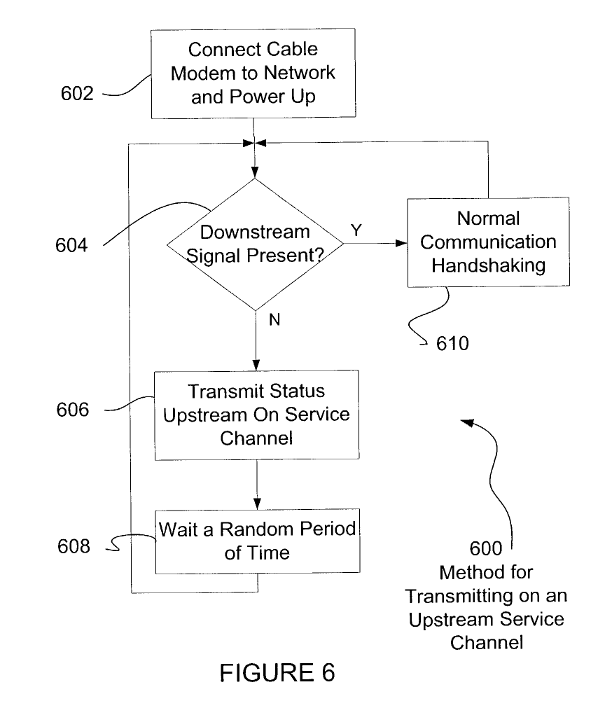

FIG. 6 illustrates an embodiment 600 of a method for transmitting on a service channel when offline. The cable modem is connected to the network in block 202, and the downstream signal is sensed in block 204. If no downstream signal is present in block 204, the cable modem transmits its status upstream on a service channel in block 206 before waiting a random period of time in block 208 and returning to check for a downstream signal in block 204. If a downstream signal is present in block 204, the normal, two-way communication handshaking is established in block 210. The process returns to block 204 and, should any problem with the downstream signal occur, the process is repeated.

The present embodiment illustrates a method whereby a cable modem transmits on the service channel only when a problem exists. Such an embodiment may keep the number of cable modems transmitting on the service channel to a minimum. The benefits are that the service channel may be monitored to identify problems with the network, as the only cable modems that are transmitting are those that are experiencing a problem with the downstream communication.

In a network where multiple devices must communicate on a limited bandwidth, synchronized transmissions utilize the bandwidth efficiently so that hundreds if not thousands of devices may share the same medium. Such transmissions rely on proper functioning of both upstream and downstream paths. If the downstream path is not properly functioning, the device may be capable of communicating relevant and useful information to the network controller. This information may be used by service technicians in assisting the consumer in proper installation of the equipment as well as by maintenance engineers to identify problem areas of the network. The difficulty lies in having many devices transmit on the medium simultaneously. Thus, a separate service channel with an appropriate protocol may be used to tolerate multiple collisions while still transmitting the necessary and useful information.

Other embodiments of the present invention may include different types of networks with network topologies similar to the two-way HFC. For example, wireless two-way networks such as cellular phone networks, IEEE 892.16 networks, and other wireless networks may benefit from having a dedicated upstream-only communication path for the network devices.

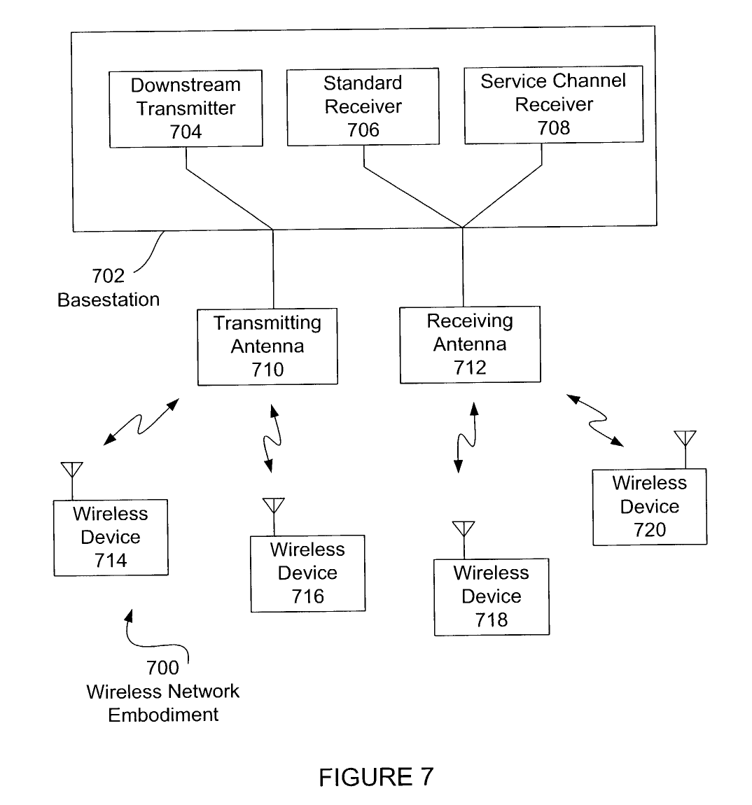

FIG. 7 illustrates a wireless embodiment 700 of the present invention. A wireless server 702 contains a downstream transmitter 704, a standard upstream receiver 706, and a service channel receiver 708. The server 702 is connected to one or more basestations 710 and 712 which transmit to wireless devices 714, 716, 718, and 720.

The wireless devices may be any type of communication device that communicates through a radio signal. Examples include telephony devices, wireless data network devices, or any other wireless device arranged in a point to multipoint communication network.

Within each wireless device, a status monitoring routine may monitor the downstream performance, similar to the status monitoring-MAC described above for a cable modem. Any impairments due to over-the-air interferences, device malfunctions, or other problems can be transmitted to the server 702 via a service channel and received by the service channel receiver 708. The message may then be transmitted to a network manager for action. In this manner, critical information regarding the transmission network or the wireless device may be transmitted without requiring an active two-way communication path.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for upstream communications in a bi-directional communications network wherein the primary form of upstream communication requires properly functioning downstream communication wherein the network is characterized by a central station and a plurality of remote transceivers comprising:
providing at least one service channel outside of the bandwidth allocated for said upstream communication;
detecting at least one problem with said downstream communication by one of said remote transceivers;
creating a status transmission comprising an identifier for said one of said remote transceivers;
sending said transmission on said at least one of said service channels from said one of said remote transceiver to said central station using said service channel;
repeating said step of sending said transmission after waiting a predetermined period of time;
receiving said transmission by said central station; and
identifying said one of said remote transceivers at said central station.

2. The method of claim 1 wherein said predetermined period of time is varied based on at least in part on a random pattern.

3. The method of claim 1 wherein said network is a cable television network.

4. The method of claim 3 wherein at least one of said plurality of remote transceivers is a cable modem.

5. The method of claim 1 wherein said network is a wireless network.

6. The method of claim 5 wherein said wireless network is a network defined at least in part by the IEEE 802.16 standard.

7. A bi-directional communications network wherein the primary form of upstream communication requires properly functioning downstream communication comprising:
at least one service channel outside of the bandwidth allocated for said upstream communication;
a central station capable of sending downstream transmissions and receiving upstream transmissions, said upstream transmissions being transmitted within a predetermined upstream bandwidth; and
a plurality of remote transceivers capable of receiving said downstream transmissions and sending said upstream transmissions, at least one of said remote transceivers capable creating a status transmission comprising an identifier for said remote transceivers, sending said transmission on said at least one service channel outside of said predetermined upstream bandwidth from said one of said remote transceiver to said central station using said service channel.

8. The network of claim 7 wherein said network is a cable television network.

9. The network of claim 8 wherein at least one of said plurality of remote transceivers is a cable modem.

10. The network of claim 7 wherein said network is a wireless network.

11. The network of claim 10 wherein said wireless network is a network defined at least in part by the IEEE 802.16 standard.
